(19) United States
(12) Patent Application Publication
(10) Pub. No.: US 2026/0319691 A1
(43) Pub. Date: Oct. 15, 2026

(54) INFORMATION LOGGING VIA A SIDEBAND WITHIN A MEMORY SYSTEM

(71) Applicant: Micron Technology, Inc., Boise, ID (US)

(72) Inventors: Sujeet V. Ayyapureddi, Boise, ID (US); Frank F. Ross, Boise, ID (US); Scott E. Schaefer, Boise, ID (US); Randall J. Rooney, Boise, ID (US); Navid Lashkarian, Pleasanton, CA (US); Matthew A. Prather, Boise, ID (US)

(21) Appl. No.: 19/467,011

(22) Filed: Feb. 2, 2026

Related U.S. Application Data
(60) Provisional application No. 63/759,890, filed on Feb. 18, 2025.

(51) Int. Cl. G06F 3/06

(52) U.S. Cl. CPC G06F 3/0655; G06F 3/0604; G06F 3/0673

(57) ABSTRACT

Methods, systems, and devices for information logging via a sideband within a memory system are described. One or more memory devices within a memory system may communicate with a baseboard management controller (BMC) via a sideband. Such communication may support relatively granular logging of information associated with the memory system. For example, the memory system may monitor one or more parameters associated with the memory system and may transmit, via the sideband, log information that logs the metrics over time. The memory system may perform the monitoring and logging concurrently with communications exchanged between the memory system and a host system via an in-band link and other corresponding access operations. The memory system may perform associated operations based on the log information during one or more idle times, to reduce interference with access operations.

### CROSS REFERENCE

The present Application for Patent claims priority to U.S. Patent Application No. 63/759,890 by Ayyapureddi et al., entitled “INFORMATION LOGGING VIA A SIDEBAND WITHIN A MEMORY SYSTEM,” filed Feb. 18, 2025, which is assigned to the assignee hereof, and which is expressly incorporated by reference in its entirety herein.

### TECHNICAL FIELD

The following relates to one or more systems for memory, including information logging via a sideband within a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports information logging via a sideband within a memory system in accordance with examples as disclosed herein.

FIG. 2 shows an example of a process flow that supports information logging via a sideband within a memory system in accordance with examples as disclosed herein.

FIG. 3 shows a block diagram of a memory system that supports information logging via a sideband within a memory system in accordance with examples as disclosed herein.

FIG. 4 shows a flowchart illustrating a method or methods that support information logging via a sideband within a memory system in accordance with examples as disclosed herein.

### DETAILED DESCRIPTION

In some systems, a memory system may perform one or more operations based on an interrupt received from a controller or host system. Additionally, or alternatively, the memory system may detect various parameters that satisfy a given threshold, and may send an interrupt to a host system to notify the host system of the threshold being satisfied. Such interrupts be conveyed via an in-band (e.g., an interface) between the memory system and the host system may block or otherwise delay other access operations and information conveyed via the in-band, which may increase latency and overhead. Some memory systems may support a reduced quantity of interrupt notifications to reduce latency. A memory system may include one or more memory devices, and each memory device may, in some cases, be capable of detecting and logging information that tracks various metrics of the memory device, such as error information, temperature information, or the like. Such logging may be done via the in-band or a serial presence detect (SPD) functionality, which may have relatively limited capacity and throughput. Thus, the amount of information the memory system may track and log may be relatively limited (e.g., only temperature and/or error information for one row or one time period, or the like). Techniques for improved capacity for enhanced tracking and logging of various metrics may be beneficial for improved user experience, among other examples.

Techniques described herein may provide for more frequent interrupts, more robust logging by a memory system, or both, by supporting communications between one or more memory devices within the memory system and a baseboard management controller (BMC) via a sideband. The BMC may be a controller within or otherwise coupled with the memory system that is configured to monitor a physical state of the memory system. The BMC may be positioned on a same module or motherboard as the memory devices within the memory system, in some examples. By communicating with the BMC via the sideband as described herein, each memory device may log additional error information and respond to interrupts without interfering with in-band communications, which may reduce latency. Additionally, or alternatively, the BMC may include or otherwise be coupled with an enhanced memory storage capacity for storing a relatively large amount of logged information, which may support more accurate and granular tracking of metrics within the memory system. The memory system may monitor one or more parameters associated with memory cells within the memory system during operation and may transmit, via the sideband, logging information that logs the metrics over time. The memory system may perform the monitoring and logging concurrently with one or more access operations performed on the memory cells by the memory system. For example, access operations and corresponding data may be exchanged with the host system via the in-band while the logging metrics are exchanged with the BMC via the sideband. The logging information may indicate values of the one or more parameters associated with the memory cells at one or more time instances within the first duration. The parameters may include, for example, a quantity of errors within the memory cells during operation of the memory system, a temperature of the memory cells, one or more memory clearing operation indications, one or more security parameters, or any combination thereof.

In addition to applicability in memory systems as described herein, techniques for information logging via a sideband within a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving communication between a memory system and a BMC via a sideband while supporting communication between the memory system and a host via an in-band, which may reduce latency caused by some operations. Further, the described techniques may support logging of a relatively large amount of information (e.g., more granular metrics), thus resulting in improved detection (and accordingly correction) of errors, among other benefits.

Features of the disclosure are illustrated and described in the context of systems and architectures. Features of the disclosure are further illustrated and described in the context of a process flow and flowcharts.

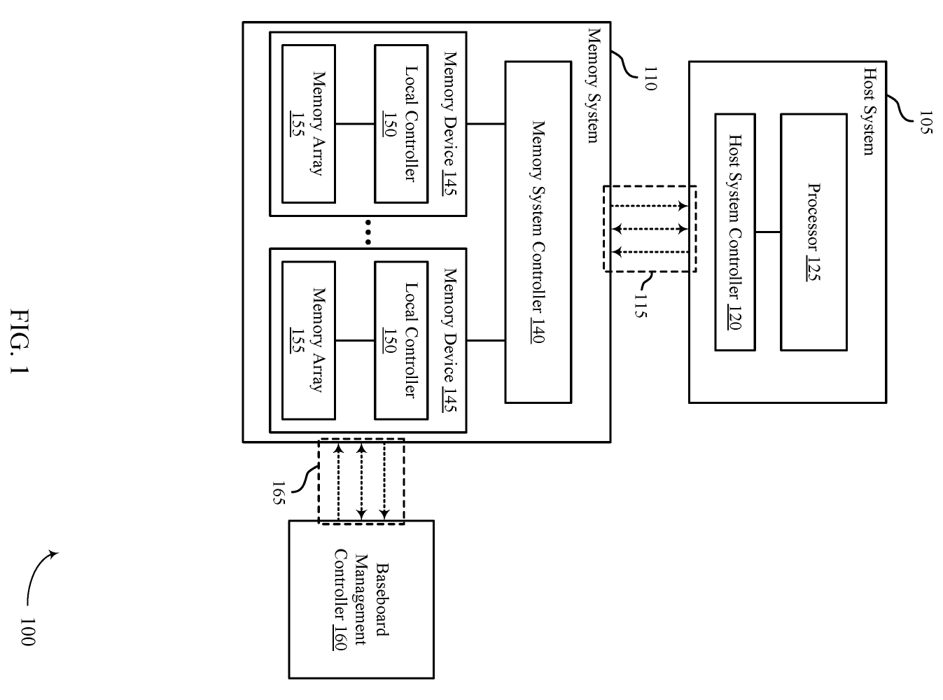

FIG. 1 shows an example of a system 100 that supports information logging via a sideband within a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array ofone or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

The system 100 may provide for relatively frequent interrupts, relatively robust logging by the memory system 110, or both, by supporting communications between one or more memory devices 145 within the memory system 110 and a BMC 160 via a sideband 165. In some examples, the sideband 165 may be an example of one or more channels or pins to communicate between the memory system 110 (e.g., one or more memory devices 145 of the memory system 110) and the BMC 160. In some cases, the BMC 160 may be a controller within the memory system 110 or otherwise coupled with the memory system 110 and configured to monitor a physical state of the memory system 110. Such communication via the sideband 165 may provide for each memory device 145 to log additional error information and to respond to interrupts in such a way to reduce latency as compared with systems in which the logging is done via the in-band channels 115.

The memory system 110 may monitor one or more parameters associated with memory cells within the memory system 110 during operation of the memory system 110 and may transmit, via the sideband 165, logging information that logs the metrics over time during operation of the memory system 110. In some examples, each memory device 145 may be coupled with a same sideband 165 or respective sidebands 165, and the logging may be done per memory device 145 within the memory system 110. The memory system 110 may perform the monitoring and logging concurrently with one or more access operations performed on the memory cells by the memory system 110. For example, access operations and corresponding data may be exchanged with the host system 105 via the in-band (e.g., the channels 115), while the logging metrics may be exchanged via the sideband 165. The log information may indicate values of the one or more parameters associated with the set of memory cells at a set of instances within the first duration. The parameters may include, for example, a quantity of errors within the memory cells during operation of the memory system 110, a temperature of the memory cells, one or more memory clearing operation indications, one or more security parameters, or any combination thereof.

As described herein, a sideband (e.g., the sideband 165) may refer to a first set of pins (e.g., I/O pins) of the memory system 110. The memory system 110 may exchange information with the BMC 160 via the sideband (e.g., through the first set of pins). An in-band (e.g., associated with the one or more channels 115) may refer to a second set pins of the memory system 110. The memory system 110 may exchange information with the host system 105 via the in-band. The second set of pins may be separate from and non-overlapping with the first set of pins. The sideband may be virtualized or non-virtualized. For example, the first set of pins may be a fixed set of pins or a dynamic set of pins. That is, the memory system 110 may use a subset of pins for the in-band during a first duration, and may use the subset of pins for the sideband during a second duration. In any case, during any given duration, the first set of pins and the second set of pins may be non-overlapping for communication with the BMC 160 and the host system 105.

As described herein, a BMC (e.g., the BMC 160) may refer to a controller residing on a motherboard (e.g., external to the memory system 110) or a controller within the memory system 110. In some cases, a BMC may be independent from the memory system 110 and from the host system 105. A BMC may manage a server based on one or more inputs (e.g., from the memory system 110 or the host system 105). The server may be associated with the memory system 110, the host system 105, one or more applications, or any combination thereof. However, the BMC may not be connected to a host. In some examples, the BMC may manage a board while the host may manage one or more memories (e.g., the memory system 110).

As described herein, the terms “queue” and “buffer” may be used interchangeably and may refer to one or more memory locations or registers. The memory system 110 may store a queue that includes commands associated with operations to be performed by the memory system 110. The host system 105 and the BMC 160 may access the queue (e.g., a “shared” queue). In accordance with one or more indications from the host system 105, the BMC 160, or both, the memory system 110 may modify the queue (e.g., adding, removing, and completing commands). Commands within the queue may be non-immediate commands to be completed by the memory system 110 eventually (e.g., non-urgent commands).

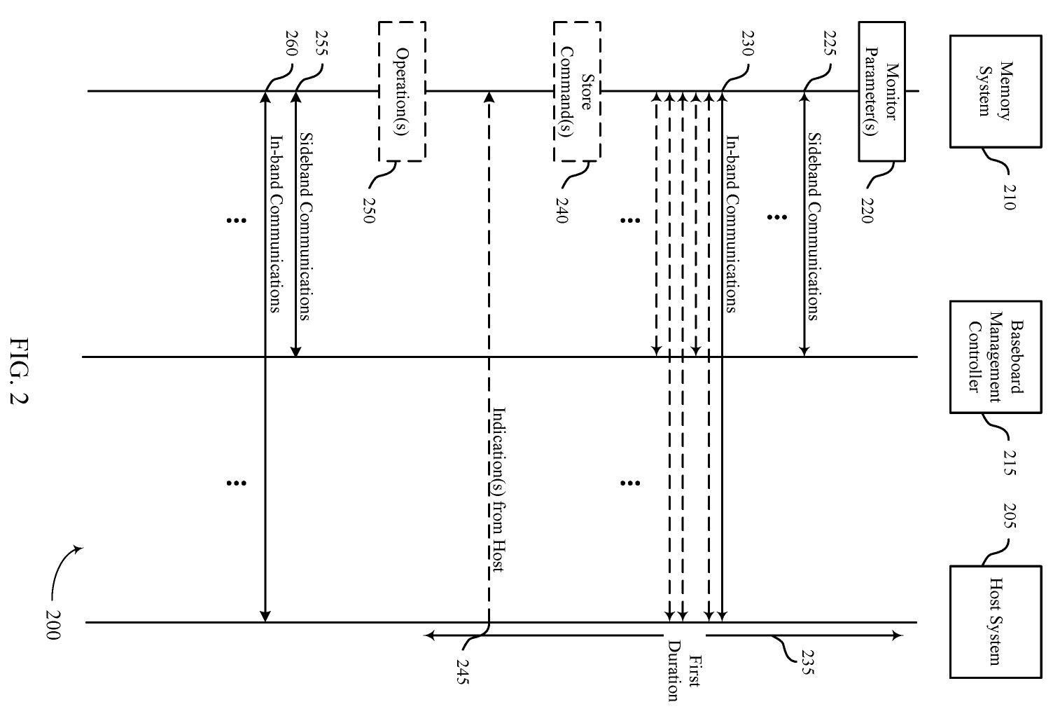

FIG. 2 shows an example of a process flow 200 that supports information logging via a sideband within a memory system in accordance with examples as disclosed herein. The process flow 200 includes a memory system 210, a BMC 215, and a host system 205, which may be examples of the corresponding devices as described with respect to FIG. 1. In some cases, the BMC 215 may be coupled with (e.g., positioned on or external to) the memory system 210. Additionally, or alternatively, the BMC 215 may be included in the memory system 210. Accordingly, communications described between the memory system 210 and the BMC 215 may, in some cases, be interpreted to be internal to the memory system 210 (e.g., between a memory device within the memory system 210 and the BMC 215). In some examples, the host system 205 may refer to a system-on-chip (SoC) associated with the memory system 210.

In the following description of the process flow 200, the operations between the memory system 210, the BMC 215, and the host system 205 may be performed in a different order than the example order shown. Some operations may also be omitted from the process flow 200, and other operations may be added to the process flow 200. Further, although some operations or signaling may be shown to occur at different times for discussion purposes, these operations may actually occur at the same time.

At 220, the memory system 210 may monitor one or more parameters associated with a set of memory cells that store data within the memory system 210. The memory system 210 may perform the monitoring of the one or more parameters concurrently with one or more access operations performed on the set of memory cells by the memory system 210. For example, the memory system 210 may monitor the one or more parameters and may perform access operations on a set of memory cells within the memory system 210 during a same duration (e.g., the first duration 235). The one or more parameters may include temperature information, error information, memory refresh information, command information (e.g., command queue information), or any combination thereof. The monitoring may be performed by a memory system controller, or may be performed by a local controller within each memory device within the memory system 210 individually, or some combination thereof.

In some implementations, the memory system 210 may perform a set of communication operations (e.g., periodically or not periodically) to exchange information with the BMC 215 and the host system 205. For example, at 225, the memory system 210 may transmit log information via a sideband coupled with the BMC 215 during a first duration 235. The log information may indicate a set of values of the one or more parameters associated with the set of memory cells at a set of times within the first duration 235 (e.g., based on the monitoring at 220). The log information may be conveyed via one or more transmissions or signals over the first duration 235. For example, the memory system 210 may transmit separate transmissions of log information at each time instance within the first duration 235 (e.g., concurrently with the monitoring at 220). Additionally, or alternatively, the memory system 210 may monitor the parameters at 220 and transmit one or more bursts of log information that indicate the values of the parameters after the monitoring is complete, or at some other interval, or the like. The sideband communications may additionally, or alternatively, include one or more communications from the BMC 215 to the memory system 210.

At 230, the memory system 210 may communicate, during the first duration 235, data with the host system 205 via an in-band that is different from the sideband. The data may be associated with the one or more access operations (e.g., access commands, write data, read data, or the like). In some cases, the host system 205 may be coupled with the memory system 210 via the in-band. The data may be communicated via one or more different transmissions during the first duration 235.

It is to be understood that the sideband communications and the in-band communications may be conveyed at the same or overlapping times within the first duration 235, in some examples. For example, the memory system 210 may transmit log information via the sideband to the BMC 215 at the same time that the host system 205 transmits an access command to the memory system 210 via the in-band, among other examples. The sideband and the in-band may be separate (e.g., associated with separate pins and channels), such that the in-band transmissions may not interfere with or otherwise obstruct the sideband transmissions, and vice versa.

The sideband communications may include transmissions of log information from the memory system 210 to the BMC 215, transmissions of interrupts or other commands from the BMC 215 to the memory system 210, or both. In some examples, the memory system 210 may transmit, via the sideband, error log information that indicates one or more errors identified within the set of memory cells across a set of rows of the memory system 210. The error log information may include information that indicates a respective set of errors within the set of memory cells at each time of the set of times within the first duration 235. In some cases, the BMC 215 may store the error log information (e.g., at one or more memories of the BMC 215) in response to receiving the error log information via the sideband.

In some implementations, the memory system 210 may be associated with an error correction system (ECS) which may log a respective quantity of errors for each row within a memory device of the memory system 210. Outputting an error quantity of a “worst” row (e.g., a row with a highest error quantity) via a serial presence detect (SPD) chip (e.g., an additional chip holding information about the module) may have limited support and capacity. Accordingly, techniques described herein may support logging errors via sideband, which may allow for real-time output and error logging for a relatively large quantity of rows within the memory device (e.g., all rows within the memory device or within the memory system 210). In some cases, the memory system 210 may monitor one or more error logs (including error logs for all rows). In such cases, the memory system 210 may notify the host system 205 (e.g., via the in-band) if one or more conditions are satisfied (e.g., if one or more quantities of errors exceed a threshold).

In some implementations, the memory system 210 may monitor for row hammer attacks (e.g., by counting row accesses) at one or more memory devices of the memory system 210. The memory system 210 may transmit an indication of row access counts (or an indication of row hammer attacks) to the BMC 215 via sideband. The BMC 215 may track (e.g., store) the row access counts and may determine rows of the memory system 210 associated with row hammer attacks. An application (e.g., running at the host system 205) may monitor the BMC 215 and may remove a user from the application (e.g., kicking the user off) based on one or more detected row hammer attacks.

Additionally, or alternatively, the memory system 210 may transmit, via the sideband, temperature information that indicates one or more measured temperatures of the memory system 210 at each time of the set of times within the first duration 235. In some examples, the BMC 215 may store the temperature information at the BMC 215. In some implementations, the memory system 210 may include a temperature sensor (e.g., on a die associated with the memory system 210) or a register associated with temperature (e.g., a mode register 4 (MR4)). The temperature sensor or the register may indicate (e.g., to the memory system 210) the temperature information, indicating whether a temperature of the memory system 210 is within a threshold range. In response to the indication of the temperature information, the memory system 210 may transmit the temperature information via the sideband.

In some cases, the memory system 210 may receive (e.g., from the host system or from the BMC 215) an indication to perform one or more thermal control operations. For example, the host system 205 (or the BMC 215) may transmit the indication based on the temperature information indicating that at least a threshold quantity of temperature measurements exceed a threshold temperature (and the memory system 210 may accordingly receive the indication). In some implementations, the BMC 215 may monitor the temperature information (e.g., directly). Accordingly, the BMC 215 may transmit indications to perform the one or more thermal control operations, and the host system 205 may transmit one or more indications to refresh a set of memory cells of the memory system 210 (e.g., based on one or more parameters such as the temperature information).

In some cases, the memory system 210 may receive one or more commands from the BMC 215 via the sideband and in response to the log information. The one or more commands may indicate one or more operations associated with second data. Additionally, or alternatively, the memory system 210 may determine to perform the one or more operations based on a value of at least one parameter of the one or more parameters satisfying (e.g., exceeding) a threshold value. In some examples, the memory system 210 may transmit a request to perform the one or more operations to the host system 205 via the in-band. The memory system 210 may transmit the request based on the log information. In some cases, the one or more commands may indicate operations to be performed within the memory system 210 based on the log information.

At 240, in some examples, the memory system 210 may store the one or more commands to a command queue (e.g., in response to the one or more commands). The command queue may be coupled with (e.g., accessible by) the BMC 215 and the host system 205. In some examples, a memory device of the memory system 210 (e.g., a DRAM device) may use the command queue to queue or buffer any delayed notifications received at the memory system 210 via the sideband. The host system 205 may monitor the command queue and identify when an interrupt may be beneficial to provide time for the memory system 210 to execute the queued commands.

At 245, the memory system 210 may receive one or more indications from the host system 205 via the in-band (or in some cases, from another device as described herein). For example, the memory system 210 may receive one or more interrupts (e.g., hardware interrupts) generated by the host system 205, the BMC 215, or both. In some examples, the BMC 215 may generate one or more software interrupts. The host system 205 may receive the one or more software interrupts (e.g., via software at the host system 205). In response, the host system 205 may translate the one or more software interrupts to hardware interrupts (e.g., as part of the one or more interrupts). In any case, the memory system 210 may receive the one or more interrupts (e.g., hardware interrupts) from the host system 205 (e.g., even though at least one interrupt may have been generated at the BMC 215). The memory system 210 may receive the one or more interrupts based on the log information transmitted to the BMC 215 (e.g., via the sideband). In some cases, the BMC 215 may generate a hardware interrupt (e.g., by itself, without a translation from the host system 205). In some implementations, the memory system 210 may receive a no operation (e.g., NO-OP) indication from the host system 205 via the in-band. The no operation indication may indicate one or more time slots included within the second duration.

Additionally, or alternatively, the memory system 210 may receive an indication of one or more time slots (e.g., an indication of future empty slots) from the host system 205 (e.g., from an SoC) via the in-band. The one or more time slots may be available for the memory system 210 to perform the one or more operations on the second data within the memory system 210. In some implementations, a controller of the memory system 210 may receive the indication of the one or more time slots and in response may communicate the one or more time slots to a memory device of the memory system 210 (e.g., a DRAM device). In some examples, the memory system 210 may receive the indication of the one or more time slots based on a quantity of commands within the command queue satisfying (e.g., exceeding) a threshold quantity. For example, the host system 205 may monitor the command queue and may signal empty slots to the memory system 210 when the host system 205 identifies that the command queue satisfies a threshold capacity (e.g., when the command queue is full).

At 250, the memory system 210 may perform a set of operations. The set of operations may include thermal control operations, refresh management operations, memory clearing operations, training operations, temperature adjustment operations, error correction operations, or other types of operations. The set of operations may be performed based on commands stored to the command queue of the memory system, based on commands received from the BMC 215 via the sideband communications, based on commands received from the host system 205 via the in-band, based on one or more thresholds detected by the memory system 210 based on the monitoring, or any combination thereof. The memory system 210 may repurpose the no-operation indications, the indicated idle time periods, or both, as provided by the host system 205, to perform the operations (e.g., during a break or pause in in-band communications).

In some implementations, the memory system 210 may perform the one or more operations associated with the second data. The memory system 210 may perform the one or more operations on the second data during a second duration associated with a pause in the one or more other access operations. For example, the second duration associated with the pause may correspond with an end of the first duration 235. That is, the end of the first duration 235 (and the beginning of the second duration) may be defined as a pause in in-band and sideband communications. Accordingly, the second duration may be a time during which in-band and sideband communications are paused (e.g., stopped) to allow for the one or more operations associated with the second data to be performed. The second data may be stored within the set of memory cells of the memory system 210.

In some cases, the memory system 210 may perform the one or more operations associated with the second data based on (e.g., in response to) one or more commands, one or more interrupts, one or more indications, one or more parameters, other information, or any combination thereof. For example, the memory system 210 may perform the one or more operations based on the log information. In some examples, the memory system 210 may perform the one or more operations based on the one or more commands received via the sideband. In some implementations, the memory system 210 may perform the one or more operations based on the one or more hardware interrupts (e.g., received via the in-band). In some implementations, the memory system 210 may perform the one or more operations based on the request. Additionally, or alternatively, the memory system 210 may perform the one or more operations based on the no operation indication from the host system 205. In any case, the one or more operations associated with the second data may include one or more refresh operations, one or more refresh management operations, one or more error correction operations, one or more memory clearing operations, one or more thermal control operations, or any combination thereof.

In some cases, in response to the indication of the one or more time slots (e.g., received via the in-band), the memory system 210 may perform the one or more operations. For example, the memory system 210 may perform the one or more operations on the second data (e.g., stored within the set of memory cells of the memory system 210) during the one or more time slots indicated by the host system 205. In such cases, the memory system 210 may perform the one or more operations based on the log information.

In some examples, the memory system 210 may perform one or more thermal control operations in response to the indication to perform the one or more thermal control operations received via the in-band. Additionally, or alternatively, the memory system 210 may perform the one or more thermal control operations while performing one or more access operations and while performing in-band communications with the host system 205. The thermal control operations may include cooling operations, thermal mitigation operations, thermal throttling, other temperature management operations, or any combination thereof. For example, the memory system 210 may include one or more fans or other cooling or thermal control components that may operate while the memory system 210 is performing other access operations. The commands from the BMC 215 may thereby trigger the memory system 210 to initiate the thermal control components without any interruptions. In some implementations, the memory system 210 may perform the one or more thermal control operations without having received an indication to do so via the in-band (e.g., based on detecting that one or more temperature parameters satisfy a threshold as described herein).

At 255, the memory system 210 may continue to perform sideband communications (e.g., as part of the periodic exchange of information with the BMC 215). Similarly, at 260, the memory system 210 may continue to perform in-band communications (e.g., as part of the periodic exchange of information with the host system 205). Accordingly, in some cases, the memory system 210 may repeat one or more processes or operations as described herein during or between subsequent exchanges of information between the memory system 210, the BMC 215, and the host system 205.

The memory system 210 may thereby use the sideband to log information and convey (e.g., transmit or receive) non-immediate interrupt notifications to and from the BMC 215 while continuing to perform in-band communications and associated access operations with the host system 205. The sideband as described herein may provide for reduced latency as compared with systems in which such notifications and logging information are conveyed via the in-band. Additionally, or alternatively, the described techniques may provide for enhanced support of logging by the memory system 210, as the memory system 210 may convey relatively granular log information to be stored by the BMC 215 (e.g., error information per row over the first duration 235, temperature information relatively frequently, or the like). The BMC 215 may store such log information for subsequent use by the host system 205, an administrator or user of the device, or both, to improve training, error detection, and device improvement and development operations, among other examples.

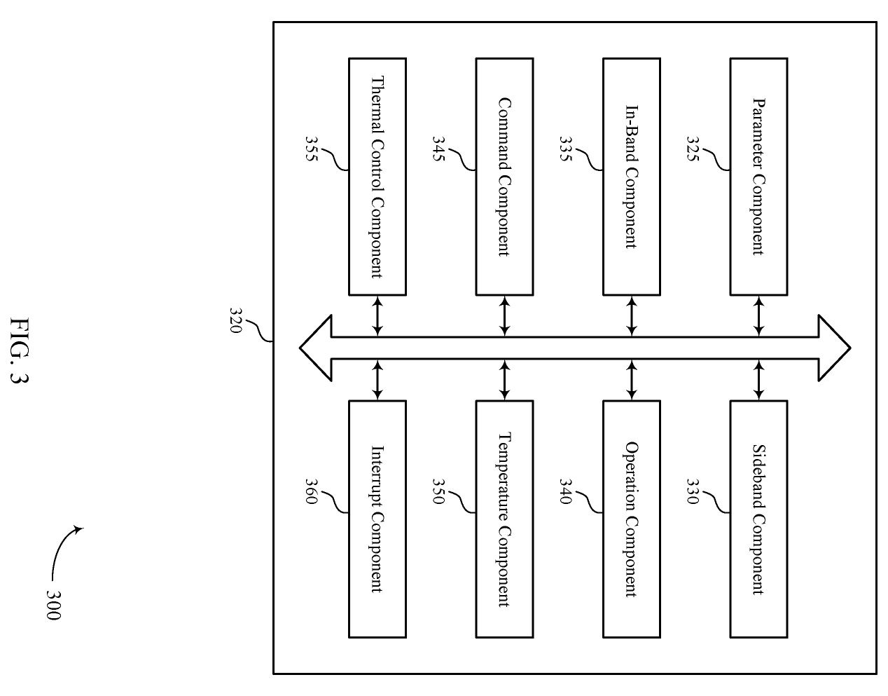

FIG. 3 shows a block diagram 300 of a memory system 320 that supports information logging via a sideband within a memory system in accordance with examples as disclosed herein. The memory system 320 may be an example of aspects of a memory system as described with reference to FIGS. 1 through 2. The memory system 320, or various components thereof, may be an example of means for performing various aspects of information logging via a sideband within a memory system as described herein. For example, the memory system 320 may include a parameter component 325, a sideband component 330, an in-band component 335, an operation component 340, a command component 345, a temperature component 350, a thermal control component 355, an interrupt component 360, or any combination thereof. Each of these components, or components of subcomponents thereof (e.g., one or more processors, one or more memories), may communicate, directly or indirectly, with one another (e.g., via one or more buses).

The parameter component 325 may be configured as or otherwise support a means for monitoring one or more parameters associated with a plurality of memory cells that store data within the memory system, where the monitoring is performed concurrently with one or more access operations performed on the plurality of memory cells by the memory system. The sideband component 330 may be configured as or otherwise support a means for transmitting, via a sideband coupled with a baseboard management controller associated with the memory system and during a first duration, log information that indicates a plurality of values of the one or more parameters associated with the plurality of memory cells at a plurality of times within the first duration. The in-band component 335 may be configured as or otherwise support a means for communicating, with a host system via an in-band that is different from the sideband and during the first duration, data associated with the one or more other access operations, where the host system is coupled with the memory system via the in-band.

In some examples, to support transmitting the log information, the sideband component 330 may be configured as or otherwise support a means for transmitting, via the sideband, error log information that indicates one or more errors identified within the plurality of memory cells across a plurality of rows of the memory system, the error log information including information that indicates a respective set of errors within the plurality of memory cells at each time of the plurality of times within the first duration, where the error log information is stored at the baseboard management controller.

In some examples, to support transmitting the log information, the sideband component 330 may be configured as or otherwise support a means for transmitting, via the sideband, temperature information that indicates one or more measured temperatures of the memory system at each time of the plurality of times within the first duration, where the temperature information is stored at the baseboard management controller.

In some examples, the temperature component 350 may be configured as or otherwise support a means for receiving, based at least in part on the temperature information indicating that at least a threshold quantity of temperature measurements exceed a threshold temperature, an indication to perform one or more thermal control operations. In some examples, the thermal control component 355 may be configured as or otherwise support a means for performing the one or more thermal control operations in response to the indication.

In some examples, the operation component 340 may be configured as or otherwise support a means for performing, by the memory system during a second duration associated with a pause in the one or more other access operations, one or more operations on second data stored within the plurality of memory cells of the memory system, where the one or more operations are based at least in part on the log information.

In some examples, the sideband component 330 may be configured as or otherwise support a means for receiving, from the baseboard management controller via the sideband and in response to the log information, one or more commands that indicate the one or more operations, where performing the one or more operations is based at least in part on the one or more commands.

In some examples, the interrupt component 360 may be configured as or otherwise support a means for receiving one or more hardware interrupts generated by the host system, the baseboard management controller, or both based at least in part on the log information transmitted to the baseboard management controller, where performing the one or more operations is based at least in part on the one or more hardware interrupts.

In some examples, the parameter component 325 may be configured as or otherwise support a means for determining to perform the one or more operations based at least in part on a value of at least one parameter of the one or more parameters exceeding a threshold value.

In some examples, the in-band component 335 may be configured as or otherwise support a means for transmitting, to the host system via the in-band, a request to perform the one or more operations based at least in part on the log information, where performing the one or more operations is based at least in part on the request.

In some examples, the in-band component 335 may be configured as or otherwise support a means for receiving, from the host system via the in-band, a no operation indication that indicates one or more time slots included within the second duration, where performing the one or more operations is based at least in part on the no operation indication.

In some examples, the one or more operations include one or more refresh operations, one or more refresh management operations, one or more error correction operations, one or more memory clearing operations, one or more thermal control operations, or any combination thereof.

In some examples, the in-band component 335 may be configured as or otherwise support a means for receiving, from the host system via the in-band, an indication of one or more time slots available for the memory system to perform one or more operations on second data within the memory system. In some examples, the operation component 340 may be configured as or otherwise support a means for performing, during the one or more time slots indicated by the host system, the one or more operations on the second data stored within the plurality of memory cells of the memory system, the one or more operations based at least in part on the log information.

In some examples, the sideband component 330 may be configured as or otherwise support a means for receiving, from the baseboard management controller via the sideband, one or more commands that indicate operations to be performed within the memory system based at least in part on the log information. In some examples, the command component 345 may be configured as or otherwise support a means for storing the one or more commands to a command queue coupled with the baseboard management controller and the host system. In some examples, the in-band component 335 may be configured as or otherwise support a means for receiving, from the host system via the in-band and based at least in part on a quantity of commands within the command queue exceeding a threshold quantity, an indication of one or more time slots available for the memory system to perform the operations. In some examples, the operation component 340 may be configured as or otherwise support a means for performing, during the one or more time slots indicated by the host system, the operations on second data stored within the plurality of memory cells of the memory system.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

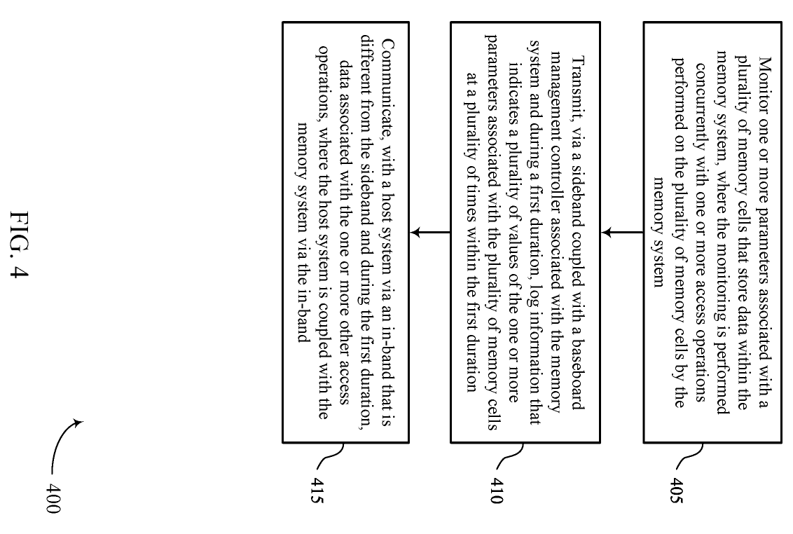

FIG. 4 shows a flowchart illustrating a method 400 that supports information logging via a sideband within a memory system in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include monitoring one or more parameters associated with a plurality of memory cells that store data within the memory system, where the monitoring is performed concurrently with one or more access operations performed on the plurality of memory cells by the memory system. In some examples, aspects of the operations of 405 may be performed by a parameter component 325 as described with reference to FIG. 3.

At 410, the method may include transmitting, via a sideband coupled with a baseboard management controller associated with the memory system and during a first duration, log information that indicates a plurality of values of the one or more parameters associated with the plurality of memory cells at a plurality of times within the first duration. In some examples, aspects of the operations of 410 may be performed by a sideband component 330 as described with reference to FIG. 3.

At 415, the method may include communicating, with a host system via an in-band that is different from the sideband and during the first duration, data associated with the one or more other access operations, where the host system is coupled with the memory system via the in-band. In some examples, aspects of the operations of 415 may be performed by an in-band component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing (e.g., to cause the apparatus to perform) the following aspects of the present disclosure:

Aspect 1: A method, apparatus, or non-transitory computer-readable medium including operations, features, circuitry, logic, means, or instructions, or any combination thereof for monitoring one or more parameters associated with a plurality of memory cells that store data within the memory system, where the monitoring is performed concurrently with one or more access operations performed on the plurality of memory cells by the memory system; transmitting, via a sideband coupled with a baseboard management controller associated with the memory system and during a first duration, log information that indicates a plurality of values of the one or more parameters associated with the plurality of memory cells at a plurality of times within the first duration; and communicating, with a host system via an in-band that is different from the sideband and during the first duration, data associated with the one or more other access operations, where the host system is coupled with the memory system via the in-band.

Aspect 2: The method, apparatus, or non-transitory computer-readable medium of aspect 1, where transmitting the log information includes operations, features, circuitry, logic, means, or instructions, or any combination thereof for transmitting, via the sideband, error log information that indicates one or more errors identified within the plurality of memory cells across a plurality of rows of the memory system, the error log information including information that indicates a respective set of errors within the plurality of memory cells at each time of the plurality of times within the first duration, where the error log information is stored at the baseboard management controller.

Aspect 3: The method, apparatus, or non-transitory computer-readable medium of any of aspects 1 through 2, where transmitting the log information includes operations, features, circuitry, logic, means, or instructions, or any combination thereof for transmitting, via the sideband, temperature information that indicates one or more measured temperatures of the memory system at each time of the plurality of times within the first duration, where the temperature information is stored at the baseboard management controller.

Aspect 4: The method, apparatus, or non-transitory computer-readable medium of aspect 3, further including operations, features, circuitry, logic, means, or instructions, or any combination thereof for receiving, based at least in part on the temperature information indicating that at least a threshold quantity of temperature measurements exceed a threshold temperature, an indication to perform one or more thermal control operations and performing the one or more thermal control operations in response to the indication.

Aspect 5: The method, apparatus, or non-transitory computer-readable medium of any of aspects 1 through 4, further including operations, features, circuitry, logic, means, or instructions, or any combination thereof for performing, by the memory system during a second duration associated with a pause in the one or more other access operations, one or more operations on second data stored within the plurality of memory cells of the memory system, where the one or more operations are based at least in part on the log information.

Aspect 6: The method, apparatus, or non-transitory computer-readable medium of aspect 5, further including operations, features, circuitry, logic, means, or instructions, or any combination thereof for receiving, from the baseboard management controller via the sideband and in response to the log information, one or more commands that indicate the one or more operations, where performing the one or more operations is based at least in part on the one or more commands.

Aspect 7: The method, apparatus, or non-transitory computer-readable medium of any of aspects 5 through 6, further including operations, features, circuitry, logic, means, or instructions, or any combination thereof for receiving one or more hardware interrupts generated by the host system, the baseboard management controller, or both based at least in part on the log information transmitted to the baseboard management controller, where performing the one or more operations is based at least in part on the one or more hardware interrupts.

Aspect 8: The method, apparatus, or non-transitory computer-readable medium of any of aspects 5 through 7, further including operations, features, circuitry, logic, means, or instructions, or any combination thereof for determining to perform the one or more operations based at least in part on a value of at least one parameter of the one or more parameters exceeding a threshold value.

Aspect 9: The method, apparatus, or non-transitory computer-readable medium of any of aspects 5 through 8, further including operations, features, circuitry, logic, means, or instructions, or any combination thereof for transmitting, to the host system via the in-band, a request to perform the one or more operations based at least in part on the log information, where performing the one or more operations is based at least in part on the request.

Aspect 10: The method, apparatus, or non-transitory computer-readable medium of any of aspects 5 through 9, further including operations, features, circuitry, logic, means, or instructions, or any combination thereof for receiving, from the host system via the in-band, a no operation indication that indicates one or more time slots included within the second duration, where performing the one or more operations is based at least in part on the no operation indication.

Aspect 11: The method, apparatus, or non-transitory computer-readable medium of any of aspects 5 through 10, where the one or more operations include one or more refresh operations, one or more refresh management operations, one or more error correction operations, one or more memory clearing operations, one or more thermal control operations, or any combination thereof.

Aspect 12: The method, apparatus, or non-transitory computer-readable medium of any of aspects 1 through 11, further including operations, features, circuitry, logic, means, or instructions, or any combination thereof for receiving, from the host system via the in-band, an indication of one or more time slots available for the memory system to perform one or more operations on second data within the memory system and performing, during the one or more time slots indicated by the host system, the one or more operations on the second data stored within the plurality of memory cells of the memory system, the one or more operations based at least in part on the log information.

Aspect 13: The method, apparatus, or non-transitory computer-readable medium of any of aspects 1 through 12, further including operations, features, circuitry, logic, means, or instructions, or any combination thereof for receiving, from the baseboard management controller via the sideband, one or more commands that indicate operations to be performed within the memory system based at least in part on the log information; storing the one or more commands to a command queue coupled with the baseboard management controller and the host system; receiving, from the host system via the in-band and based at least in part on a quantity of commands within the command queue exceeding a threshold quantity, an indication of one or more time slots available for the memory system to perform the operations; and performing, during the one or more time slots indicated by the host system, the operations on second data stored within the plurality of memory cells of the memory system.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
monitor one or more parameters associated with a plurality of memory cells that store data within the memory system, wherein the monitoring is performed concurrently with one or more access operations performed on the plurality of memory cells by the memory system;
transmit, via a sideband coupled with a baseboard management controller associated with the memory system and during a first duration, log information that indicates a plurality of values of the one or more parameters associated with the plurality of memory cells at a plurality of times within the first duration; and
communicate, with a host system via an in-band that is different from the sideband and during the first duration, data associated with the one or more other access operations, wherein the host system is coupled with the memory system via the in-band.

2. The memory system of claim 1, wherein, to transmit the log information, the processing circuitry is further configured to cause the memory system to:
transmit, via the sideband, error log information that indicates one or more errors identified within the plurality of memory cells across a plurality of rows of the memory system, the error log information comprising information that indicates a respective set of errors within the plurality of memory cells at each time of the plurality of times within the first duration, wherein the error log information is stored at the baseboard management controller.

3. The memory system of claim 1, wherein, to transmit the log information, the processing circuitry is further configured to cause the memory system to:
transmit, via the sideband, temperature information that indicates one or more measured temperatures of the memory system at each time of the plurality of times within the first duration, wherein the temperature information is stored at the baseboard management controller.

4. The memory system of claim 3, wherein the processing circuitry is further configured to cause the memory system to:
receive, based at least in part on the temperature information indicating that at least a threshold quantity of temperature measurements exceed a threshold temperature, an indication to perform one or more thermal control operations; and
perform the one or more thermal control operations in response to the indication.

5. The memory system of claim 1, wherein the processing circuitry is further configured to cause the memory system to:
perform, by the memory system during a second duration associated with a pause in the one or more other access operations, one or more operations on second data stored within the plurality of memory cells of the memory system, wherein the one or more operations are based at least in part on the log information.

6. The memory system of claim 5, wherein the processing circuitry is further configured to cause the memory system to:
receive, from the baseboard management controller via the sideband and in response to the log information, one or more commands that indicate the one or more operations, wherein performing the one or more operations is based at least in part on the one or more commands.

7. The memory system of claim 5, wherein the processing circuitry is further configured to cause the memory system to:
receive one or more hardware interrupts generated by the host system, the baseboard management controller, or both based at least in part on the log information transmitted to the baseboard management controller, wherein performing the one or more operations is based at least in part on the one or more hardware interrupts.

8. The memory system of claim 5, wherein the processing circuitry is further configured to cause the memory system to:
determine to perform the one or more operations based at least in part on a value of at least one parameter of the one or more parameters exceeding a threshold value.

9. The memory system of claim 5, wherein the processing circuitry is further configured to cause the memory system to:
transmit, to the host system via the in-band, a request to perform the one or more operations based at least in part on the log information, wherein performing the one or more operations is based at least in part on the request.

10. The memory system of claim 5, wherein the processing circuitry is further configured to cause the memory system to:
receive, from the host system via the in-band, a no operation indication that indicates one or more time slots included within the second duration, wherein performing the one or more operations is based at least in part on the no operation indication.

11. The memory system of claim 5, wherein the one or more operations comprise one or more refresh operations, one or more refresh management operations, one or more error correction operations, one or more memory clearing operations, one or more thermal control operations, or any combination thereof.

12. The memory system of claim 1, wherein the processing circuitry is further configured to cause the memory system to:
receive, from the host system via the in-band, an indication of one or more time slots available for the memory system to perform one or more operations on second data within the memory system; and
perform, during the one or more time slots indicated by the host system, the one or more operations on the second data stored within the plurality of memory cells of the memory system, the one or more operations based at least in part on the log information.

13. The memory system of claim 1, wherein the processing circuitry is further configured to cause the memory system to:
receive, from the baseboard management controller via the sideband, one or more commands that indicate operations to be performed within the memory system based at least in part on the log information;
store the one or more commands to a command queue coupled with the baseboard management controller and the host system;
receive, from the host system via the in-band and based at least in part on a quantity of commands within the command queue exceeding a threshold quantity, an indication of one or more time slots available for the memory system to perform the operations; and
perform, during the one or more time slots indicated by the host system, the operations on second data stored within the plurality of memory cells of the memory system.

14. A method by a memory system, comprising:
monitoring one or more parameters associated with a plurality of memory cells that store data within the memory system, wherein the monitoring is performed concurrently with one or more access operations performed on the plurality of memory cells by the memory system;
transmitting, via a sideband coupled with a baseboard management controller associated with the memory system and during a first duration, log information that indicates a plurality of values of the one or more parameters associated with the plurality of memory cells at a plurality of times within the first duration; and
communicating, with a host system via an in-band that is different from the sideband and during the first duration, data associated with the one or more other access operations, wherein the host system is coupled with the memory system via the in-band.

15. The method of claim 14, wherein transmitting the log information comprises:
transmitting, via the sideband, error log information that indicates one or more errors identified within the plurality of memory cells across a plurality of rows of the memory system, the error log information comprising information that indicates a respective set of errors within the plurality of memory cells at each time of the plurality of times within the first duration, wherein the error log information is stored at the baseboard management controller.

16. The method of claim 14, wherein transmitting the log information comprises:
transmitting, via the sideband, temperature information that indicates one or more measured temperatures of the memory system at each time of the plurality of times within the first duration, wherein the temperature information is stored at the baseboard management controller.

17. The method of claim 14, further comprising:
performing, by the memory system during a second duration associated with a pause in the one or more other access operations, one or more operations on second data stored within the plurality of memory cells of the memory system, wherein the one or more operations are based at least in part on the log information.

18. The method of claim 14, further comprising:
receiving, from the host system via the in-band, an indication of one or more time slots available for the memory system to perform one or more operations on second data within the memory system; and
performing, during the one or more time slots indicated by the host system, the one or more operations on the second data stored within the plurality of memory cells of the memory system, the one or more operations based at least in part on the log information.

19. A non-transitory computer-readable medium storing code comprising instructions which, when executed by one or more processors of a memory system, cause the memory system to:
monitor one or more parameters associated with a plurality of memory cells that store data within the memory system, wherein the monitoring is performed concurrently with one or more access operations performed on the plurality of memory cells by the memory system;
transmit, via a sideband coupled with a baseboard management controller associated with the memory system and during a first duration, log information that indicates a plurality of values of the one or more parameters associated with the plurality of memory cells at a plurality of times within the first duration; and
communicate, with a host system via an in-band that is different from the sideband and during the first duration, data associated with the one or more other access operations, wherein the host system is coupled with the memory system via the in-band.

20. The non-transitory computer-readable medium of claim 19, wherein the instructions to transmit the log information, when executed by the one or more processors of the memory system, further cause the memory system to:
transmit, via the sideband, error log information that indicates one or more errors identified within the plurality of memory cells across a plurality of rows of the memory system, the error log information comprising information that indicates a respective set of errors within the plurality of memory cells at each time of the plurality of times within the first duration, wherein the error log information is stored at the baseboard management controller.

21. The non-transitory computer-readable medium of claim 19, wherein the instructions to transmit the log information, when executed by the one or more processors of the memory system, further cause the memory system to:
transmit, via the sideband, temperature information that indicates one or more measured temperatures of the memory system at each time of the plurality of times within the first duration, wherein the temperature information is stored at the baseboard management controller.

22. The non-transitory computer-readable medium of claim 19, wherein the instructions, when executed by the one or more processors of the memory system, cause the memory system to:
perform, by the memory system during a second duration associated with a pause in the one or more other access operations, one or more operations on second data stored within the plurality of memory cells of the memory system, wherein the one or more operations are based at least in part on the log information.
